(19) United States
(12) Patent Application Publication
(10) Pub. No.: US 2009/0319933 A1
(43) Pub. Date: Dec. 24, 2009

(54) TRANSACTED DOUBLE BUFFERING FOR GRAPHICAL USER INTERFACE RENDERING

(75) Inventors: Igor Zaika, Seattle, WA (US); Andrew Fomichev, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,760

(22) Filed: Jun. 21, 2008

(51) Int. Cl. G06F 9/44; G06F 3/048

(52) U.S. Cl. 715/772; 717/168

(57) ABSTRACT

Technologies are described herein for improving a user experience during the rendering, or repainting, of a graphical interface. A user interface related transaction can be initiated in response to a requested user operation. One or more windows associated with the requested operation can be identified. User interface updates associated with the one or more identified windows can be double buffered. Completion of the requested operation can be detected. The transaction can be terminated in response to detecting completion of the requested operation. The double buffered user interface updates can be committed to a computer display after terminating the transaction.

### BACKGROUND

Typical graphical software applications involve a user interface (UI) or graphical user interface (GUI). Examples of such software applications are those that run within, or in conjunction with, a MICROSOFT WINDOWS® operating system from MICROSOFT CORPORATION. More specifically, examples may include MICROSOFT OFFICE® office automation software from MICROSOFT CORPORATION, OUTLOOK® personal information management software from MICROSOFT CORPORATION, and MICROSOFT WORD® word processing software from MICROSOFT CORPORATION.

The GUI of a graphical software application is typically made up of multiple elements. These elements can include various controls, views, menus, toolbars, indicators, or any number of other UI elements. While the entire display space of a given application is often referred to as the application's window, the various UI elements may themselves be considered windows within the application display. At the software implementation level, these various UI elements or windows can be referenced as pointers to windows or window handles. In order to display all of the UI elements of an application, all of the associated windows within the application's display are individually drawn, rendered, or painted. This is generally done by sending a “paint” message or signal to each of the windows, or similarly by calling a paint method of a window object associated with each window within the display space of the application.

When an application is launching or is performing an operation that involves repainting the component windows, the user may experience partial or incomplete application rendering as each component window repaints in a seemingly random order with various delays. An example of when this may occur is when a file or resource is loaded over a network, taking an undetermined amount of time. Other examples relate to initial application launch or upon switching application views where a large number of recalculations of display components are undertaken.

The seemingly random delays and ordering of UI component updates can be distracting or confusing to the user. If a long delay is encountered, for example one associated with a network load, the user may be faced with a partially drawn window for an extended period. This can cause a user to become concerned that a failure has occurred. This concern may be compounded by the lack of an obvious, safe mechanism for the user to abort the operation.

It is with respect to these considerations and others that the disclosure made herein is presented.

### SUMMARY

Technologies are described herein for improving a user experience during the rendering, or repainting, of a graphical interface. In particular, techniques are described for establishing user interface related transactions, during which graphical user interface rendering can be double buffered. Extended or delayed screen updates can be performed off-screen or on a temporarily invisible screen layer until completed. Upon completion, the updates can be drawn to the screen at once. This may result in a user experience with improved smoothness and responsiveness. Graphical screen updates may be variously referred to as rendering, painting, repainting, drawing, or so forth.

According to one aspect presented herein, a transacted painting, or repainting, of a graphical user interface can be initiated in response to a user action. The transaction can be established when a particular user action may take an extended or undetermined amount of time. During the transaction, user interface rendering may be double buffered until the requested action is completed. Completion of the action may be tied to a UI state update within the application confirming that various necessary screen painting operations have terminated. Upon completion of the requested action, the double buffered screen updates can be committed to the display screen in unison so as to appear nearly instantaneous to the user. This completion of the transacted buffering can occur automatically in response to the completion of the requested action.

According to another aspect presented herein, the double buffering of screen updates may be performed across multiple GUI elements, or windows, associated with the application. A single component window, or UI element, may be double buffered to a single buffer. Also, multiple UI elements may be individually buffered. However, additional efficiency and performance may be provided by double buffering multiple UI elements associated with an application to a common double buffer for rendering.

According to yet another aspect presented herein, double buffering can also be supported by painting to a screen layer set to full transparency. Either one, or a combination, of an off screen buffer and a transparent layer may be used to provide double buffering of a GUI display.

According to yet another aspect presented herein, feedback can be provided to a user as to the progress or status of the requested action that began the transaction. For example, opening a document over a network may take an extended amount of time. During this time, progress information can be provided to the user while the rendering of their opened file is delayed by the network operation. The progress can be displayed on a splash screen that may be presented even though the actual application display is currently being double buffered off screen or on a transparent layer. The splash screen may also include a cancellation UI to provide the user a safe way to abort the operation. For example, if the user does not wish to continue waiting for completion or if the user realizes that they made an error in initiating the transaction. The splash screen, progress indicator, cancellation UI, and related operations may be executed in a separate thread, or other parallel operation, distinct from the transacted action itself. Such threading may support a very responsive splash screen even though the transacted action remains in progress.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a functional block diagram illustrating mechanisms for double buffering a graphical user interface along with a splash screen display according to aspects of an embodiment presented herein;

FIG. 2 is a logical flow diagram illustrating aspects of processes for improving the rendering of a graphical user interface according to aspects of an embodiment presented herein;

FIG. 3 is a logical flow diagram illustrating aspects of processes for transacted double buffering during graphical user interface rendering according to aspects of an embodiment presented herein;

FIG. 4 is a logical flow diagram illustrating aspects of processes for supporting a splash screen in a graphical user interface according to aspects of an embodiment presented herein; and

FIG. 5 is a computer architecture diagram showing an illustrative computer hardware and software architecture for a computing system capable of implementing aspects of an embodiment presented herein.

### DETAILED DESCRIPTION

The following detailed description is directed to technologies for establishing user interface related transactions, during which graphical user interface rendering can be double buffered. Through the use of the technologies and concepts presented herein, extended or delayed screen updates can be performed off-screen or on a temporarily invisible screen layer until completed. Upon completion, the updates can be displayed to a visible screen as a single operation. This may result in a user experience with improved responsiveness and a smooth consistency.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for establishing user interface related transactions, during which graphical user interface rendering can be double buffered will be described.

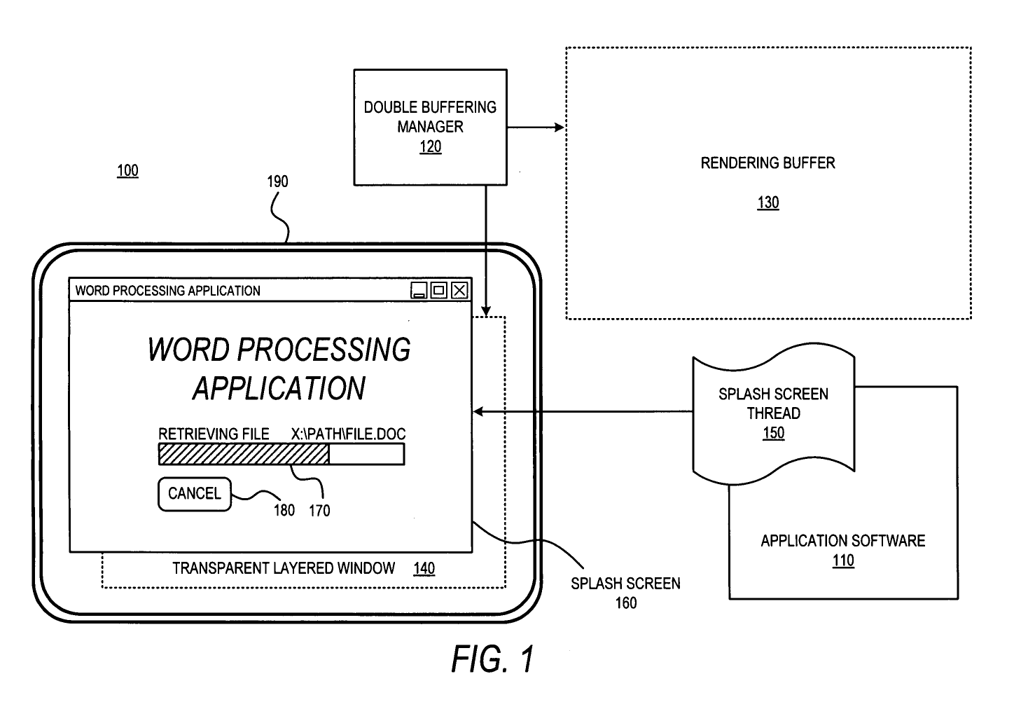

Turning now to FIG. 1, a functional block diagram illustrates a system 100 for double buffering a graphical user interface along with a splash screen 160 display according to aspects of an embodiment presented herein. In particular, a graphical user interface associated with a software application 110 can be presented on a computer display 190. When a user initiated action may involve an extended delay or an undetermined amount of time, delays may be introduced between the repainting of portions of the user interface. This may provide a user experience of prolonged partial displays, jerky rendering, or inconsistent displays. Extended delays may be introduced when an application is loading up, when a resource is loaded over a network, when a view change requires recalculating display elements, or under several other such conditions.

Transacted double buffering can support a smoother graphical user interface. An off screen rendering buffer 130 can be provided by a double buffering manager 120. The various component windows representing controls, menus, tool bars, windows, and other user interface components associated with the application 110 can be painted, or updated, to the rendering buffer 130 so that the potentially staggered, incomplete, or jerky display updates will not be visible to the user. Once the UI updates are complete, the rendering buffer 130 can be pushed to the computer display 190 in a single operation. Doing so can allow the screen updates to appear nearly instantaneous. The update may be handled by the double buffer manager 120. The double buffer manager 120 can commit updates in the rendering buffer 130 to the display 190 upon request. The double buffering manager 130 can be part of the application software 110 or may be supported by the operating system, graphics subsystem, or screen manager.

Another mechanism for double buffering can make use of a transparent layered window 140. When an application component cannot be modified to render updates to the off screen rendering buffer 130, a transparent layered window 140 approach can be used. An application component may preclude modification when there is no source code available, when it is an externally supplied library or component, such as an ACTIVE X ®control, or when time, budget, or legacy concerns prevent code modification.

A GUI component can be provided with a transparent layered window 140 to which it can paint its graphical updates. The layered window can use a graphical layer configured to full transparency such that the potentially staggered, jerky, or delayed screen updates are not visible to the user. When the screen updates are complete and the UI status has been updated, the transparency can be changed to full opacity. The layered window 140 can thus be made visible to the user in a single operation, so as to make the updates appear nearly instantaneous.

Either the off screen rendering buffer 130, the transparent layered window 140, or both in combination may be used to provide double buffering of the GUI associated with the application software 110. Once the updates are complete, display bits stored by double buffer manager 120, or associated with the rendering buffer 130, can be pushed to the layered window 140. The transparency can then be set to fully opaque and the various UI updates can be made visible to the user in unison, as a single operation.

User interface related transactions may be used to control a set of UI updates that may be collected together for double buffering. The set of UI updates within a given transaction are generally associated with a specific user action that may introduce delays, such as initially opening an application, loading a file over a network, changing UI views within an application, or other such operations. During the transaction, user interface rendering may be double buffered until the requested action is completed.

If an extended or unknown transaction time may be incurred, a splash screen 160 may be presented to the user. Since the GUI may be updating to a double buffering mechanism, such as an off screen rendering buffer 130 or a transparent layered window 140, the user may be left without screen updates were it not for the presentation of a splash screen 160. The splash screen 160 may be supported by a splash screen thread 150. The splash screen thread 150 may be part of the application software 110. The splash screen thread 150 may execute as a distinct thread, process, or other parallelized mechanism separate from the application software 110 components related to the transacted user action. Separating the operations related to the splash screen 160 into a splash screen thread 150 can allow the splash screen 160 to be updated and handled in a responsive and interactive fashion even while the transacted operation is underway, and potentially delayed.

The splash screen 160, as supported by the splash screen thread 150, can provide one or more progress indicators to the user. The progress indicators can provide the user with information about actions being performed and approximately how long the associated delays may be. An example of a progress indicator is a progress bar 170 that may show a percentage of progress for the action being performed.

The splash screen 160, as supported by the splash screen thread 150, can provide a cancellation UI to the user. For example a cancel button 180 may be positioned on the splash screen 160. Such a cancellation mechanism can provide the user with a safe way to abort the transacted operation. For example, the user may not wish to continue waiting for completion of the requested action. Similarly, the user may realize that the initiation of the transaction was made in error. In situations such as these, the cancellation UI, provided on the splash screen 160, can be operated by the user.

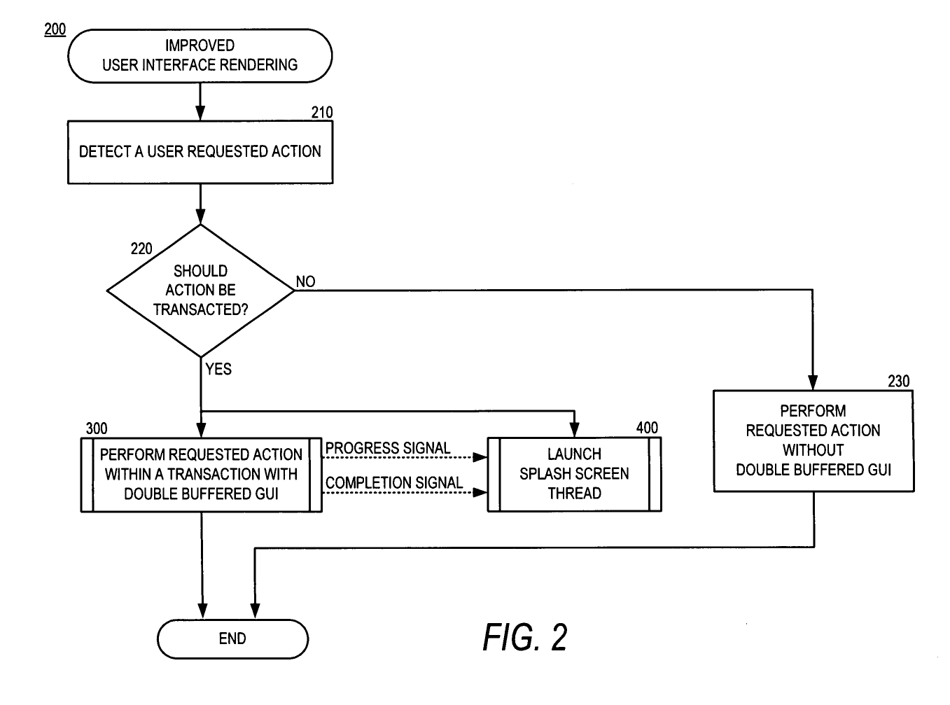

Referring now to FIG. 2, additional details will be provided regarding the embodiments presented herein for double buffering a graphical user interface while providing a splash screen display according to aspects of an embodiment presented herein. In particular, FIG. 2 is a flow diagram illustrating aspects of a routine 200 for improving the rendering of a graphical user interface.

It should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed sequentially, in parallel, or in a different order than those described herein.

The routine 200 begins at operation 210, where a user requested action can be detected. Decision operation 220 may determine to transact the requested action. Generally, an action may be transacted if it may introduce an extended delay or an unknown delay. For example, startup of an application may be transacted, particularly when a document is being opened during startup of the application. Actions that load files or access resources over a network, as well as actions involving application view changes are additional examples of actions that may be transacted. While an action that can be completed very quickly need not necessarily be transacted, such an action may be transacted without significant impact.

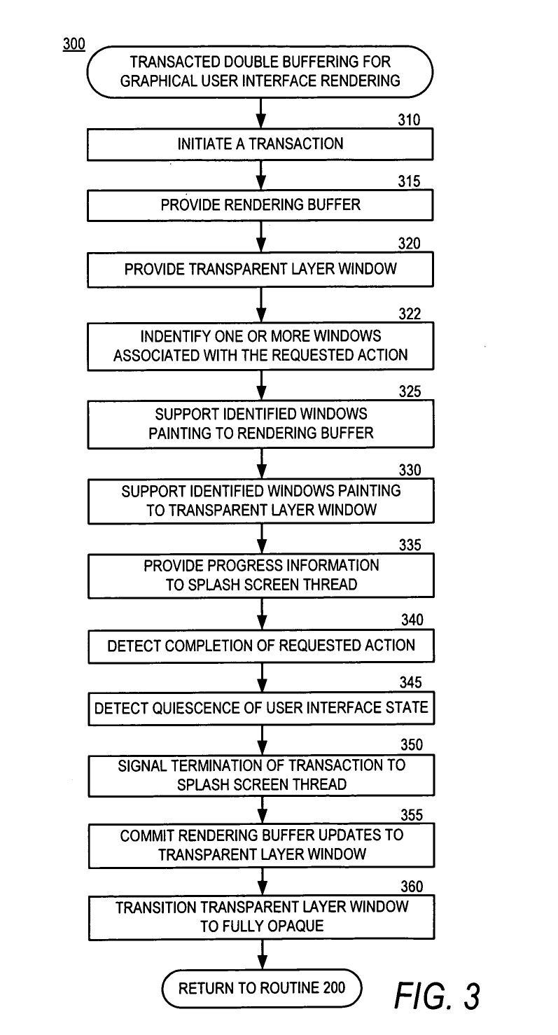

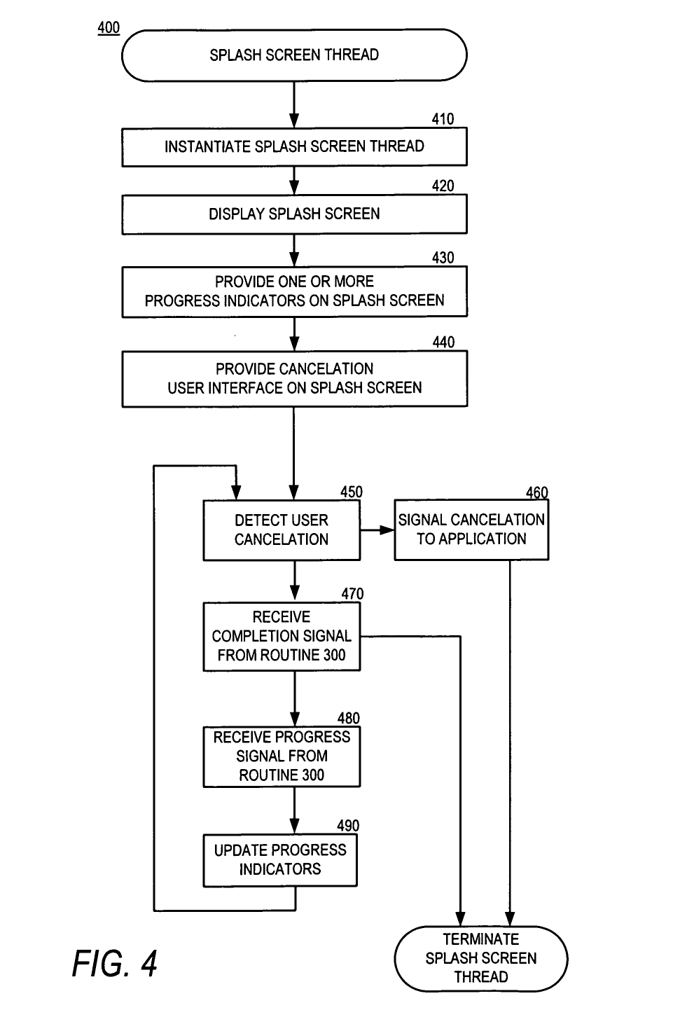

If operation 220 determines that an action is not to be transacted, the routine 200 can continue to operation 230 where the requested action can be performed without using a transacted double buffered GUI. If however, operation 220 determines that an action is to be transacted, then the routine 200 can continue to begin two operations in parallel. These two operations can be represented as routine 300 for performing the requested action with a transacted double buffered GUI, and also routine 400 where a splash screen thread can be launched. Additional details related to routine 300 and routine 400 are provided below with respect to FIG. 3 and FIG. 4.

Routine 300 can provide a progress signal to routine 400 for updating status indicators associated with the splash screen 160 such as a progress bar 170. Also, routine 300 can provide a completion signal to routine 400 for notification of the completion of the transaction associated with the requested action. Routine 200 can terminate after returning from routine 300 or after operation 230 depending upon the path taken by the routine 200.

Referring now to FIG. 3, additional details will be provided regarding the embodiments presented herein for double buffering a graphical user interface while providing a splash screen display according to aspects of an embodiment presented herein. In particular, FIG. 3 is a flow diagram illustrating aspects of a process 300 for transacted double buffering during graphical user interface rendering.

The routine 300 begins at operation 310, where a transaction can be initiated. User interface related transactions may be used to control a set of UI updates that may be collected together in double buffering. Initiating a transaction can mark the beginning of the set of UI updates to be double buffered.

At operation 315, a rendering buffer 130 can be provided. Generally, a rendering buffer 130 is provided as an off screen buffer to draw UI updates to without making them visible. The rendering buffer 130 may be provided by the double buffering manager 120. At operation 320, a transparent layer window 140 may be provided. The transparent layered window 140 may also be provided by the double buffering manager 120. The transparent layer window 140 is similar to the off screen rendering buffer 130, as it can be drawn to without being visible to the user. However, the transparent layered window 140 may actually be in the display space with its transparency set to full so as to be invisible.

At operation 322, windows may be identified as associated with the requested action. The various windows may correspond to components of the GUI used by the application software 110 while carrying out the requested action. These GUI component windows may include controls, menus, views, tool bars, or any other windows making up the GUI.

At operation 325, painting to the rendering buffer 130 can be supported while performing the requested action. In particular, painting by the windows identified in operation 322 can use the rendering buffer 130. During the double buffered transaction, UI updates related to the operation being carried out (e.g. booting an application, changing views, accessing a file, accessing a network resource, and so on) can be painted to the rendering buffer 130 off screen so that they are not visible to the user. Multiple UI components, or windows, can be double buffered by a common rendering buffer 130.

At operation 330, painting to the transparent layered window 140 can be supported as appropriate. Double buffer UI updates to a transparent layered window 140 may be appropriate when the UI code cannot be modified to render updates to an off screen rendering buffer 130. An application component, or window as identified in operation 322, may preclude modification when there is no source code available, when it is an externally supplied library or component, such as an ACTIVE X® control, or when there may be time, budget, or legacy concerns preventing code modification. Instead of using an off screen rendering buffer 130, the UI can make its updates to a transparent window layer 140 that has been configured to be fully transparent.

At operation 335, progress information can be provided to the splash screen thread 400. Such progress information can support the display of progress indicators, such as the progress bar 170, on the splash screen 160. These status indicators can provide the user with information regarding the status of the transaction while it is underway.

At operation 340, the completion of the requested action can be detected. For example, if a file is being opened, the completion of opening the file can be detected. Such detection can, in part, support the transaction being automatically terminated. At operation 345, quiescence of the user interface state can be detected. Detecting that UI updates have completed can support tying completion of the transacted action to a UI state update within the application 110. Automatic termination of the transaction can be supported, in part, by determining the completion of various necessary repaint events, such as text being rendering, buttons being enabled, buttons being disabled, and so forth.

At operation 350, completion of the transaction can be signaled to the splash screen thread 400. Notifying the splash screen thread 400 that the transaction has completed and is now terminating can support the automatic termination of the splash screen thread 400 and can discontinue the displaying of the splash screen 160.

At operation 355, updates that have been made to the rendering buffer 130 during the transaction can be committed to the computer display 190. This can be supported by the double buffering manager 120. Where a transparent layered window 140 has also been used, commit of the rendering buffer 130 bits can include drawing the updates from the rendered buffer 130 to the transparent layered window 140.

At operation 360, the transparent layered window 140 can be transitioned to being fully opaque. That is, the transparency of the layered window can be turned off. In this single operation, the collected UI updates associated with the transaction can be made visible to the user almost instantaneously. Thus, a smoother, less confusing user interface presentation may be supported. The routine 300 can return to routine 200 after operation 360.

Referring now to FIG. 4, additional details will be provided regarding the embodiments presented herein for double buffering a graphical user interface while providing a splash screen display according to aspects of an embodiment presented herein. In particular, FIG. 4 is a flow diagram illustrating aspects of a process 400 for supporting a splash screen in a graphical user interface.

The routine 400 begins at operation 410, where a splash screen thread 150 can be instantiated. At operation 420, the splash screen thread 150 can support displaying a splash screen 160 while a transacted user action is in progress. The splash screen thread 150 may be part of the application software 110 but execute in a distinct thread, process, or other parallelized mechanism from the application software 110 modules associated with the transacted user action. Such separation of operations related to the splash screen 160 into a splash screen thread 150 can allow the splash screen 160 to be updated and handled in a responsive and interactive fashion even while the transacted operation is underway, and potentially delayed.

At operation 430, the splash screen 160, as supported by the splash screen thread 150, can provide one or more progress indicators to the user. The progress indicators can provide the user with information about actions being performed and approximately how long the associated delays may be. An example of a progress indicator is the progress bar 170 that may show a percentage of progress associated with the action being performed.

At operation 440, the splash screen 160, as supported by the splash screen thread 150, can provide a cancellation UI to the user. For example, the cancel button 180 may be positioned on the splash screen 160. Such a cancellation mechanism can provide the user with a safe way to abort the transacted operation. For example, the user may not wish to continue waiting for completion of the requested action. Similarly, the user may realize that the initiation of the transaction was made in error. In situations such as these, a cancellation UI, provided on the splash screen 160, can be operated by the user. User operation of the cancellation UI can be detected by operation 450. If detected, the cancellation can be signaled to the application by operation 460. Signaling a user cancellation request to the application can support the application gracefully terminating the requested action. After operation 460, the splash screen thread 150 can be terminated and displaying of the splash screen 160 can cease.

While no cancellation is requested, operation 470 can receive a completion signal from routine 300. If the transacted action supported by routine 300 has completed, routine 400 can be notified as discussed with respect to operation 350 as illustrated in FIG. 3. The detection of this notification at operation 470 can support the termination of the splash screen thread 150 and the associated closing of the splash screen 160.

While no completion signal is detected at operation 470, operation 480 can receive a progress signal from routine 300 as discussed with respect to operation 335 as illustrated in FIG. 3. At operation 490, the progress information signaled to the routine 400 in operation 480 can be used to update the progress indicators on the splash screen 160 as provided at operation 430. After operation 490, the routine 400 can loop back to operation 450 and continue as discussed above until the transaction is canceled or completed.

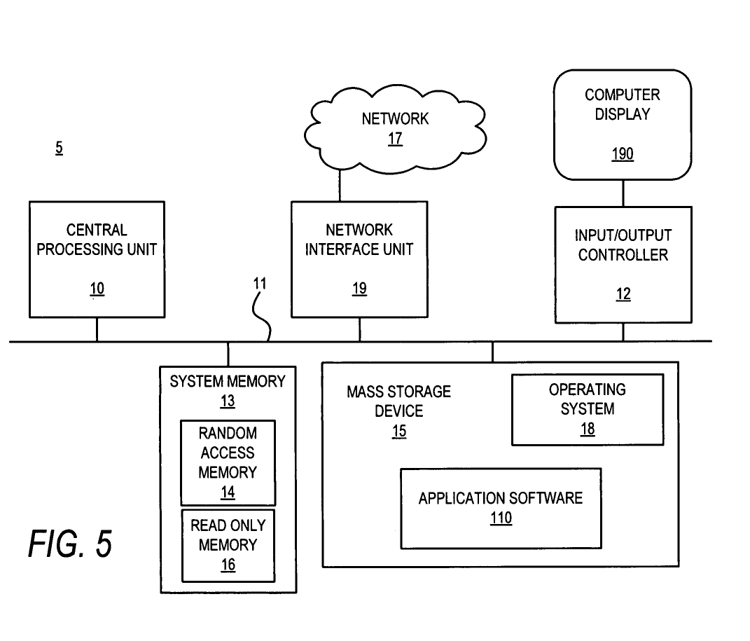

Turning now to FIG. 5, an illustrative computer architecture 5 can execute software components described herein for double buffering a graphical user interface while providing a splash screen display. The computer architecture shown in FIG. 5 illustrates a conventional desktop, laptop, or server computer and may be utilized to execute any aspects of the software components presented herein. It should be appreciated however, that the described software components can also be executed on other example computing environments, such as mobile devices, television, set-top boxes, kiosks, vehicular information systems, mobile telephones, embedded systems, or otherwise.

The computer architecture illustrated in FIG. 5 can include a central processing unit 10 (CPU), a system memory 13, including a random access memory 14 (RAM) and a read-only memory 16 (ROM), and a system bus 11 that can couple the system memory 13 to the CPU 10. A basic input/output system containing the basic routines that help to transfer information between elements within the computer 5, such as during startup, can be stored in the ROM 16. The computer 5 may further include a mass storage device 15 for storing an operating system 18, software, data, and various program modules, such as those associated with the application software 110. The application software 110 can execute the software components described herein.

The mass storage device 15 can be connected to the CPU 10 through a mass storage controller (not illustrated) connected to the bus 11. The mass storage device 15 and its associated computer-readable media can provide non-volatile storage for the computer 5. Although the description of computer-readable media contained herein refers to a mass storage device, such as a hard disk or CD-ROM drive, it should be appreciated by those skilled in the art that computer-readable media can be any available computer storage media that can be accessed by the computer 5.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 5.

According to various embodiments, the computer 5 may operate in a networked environment using logical connections to remote computers through a network such as the network 17. The computer 5 may connect to the network 17 through a network interface unit 19 connected to the bus 11. It should be appreciated that the network interface unit 19 may also be utilized to connect to other types of networks and remote computer systems. The computer 5 may also include an input/output controller 12 for receiving and processing input from a number of other devices, including a keyboard, mouse, or electronic stylus (not illustrated). Similarly, an input/output controller 12 may provide output to a computer display 190, a printer, or other type of output device (also not illustrated). The computer display 190 may alternatively be connected to the bus 11 by a graphics adapter, or graphics processing unit (also not illustrated).

As mentioned briefly above, a number of program modules and data files may be stored in the mass storage device 15 and RAM 14 of the computer 5, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the application software 110 for execution by the CPU 10. The application software 110 can include software components for implementing the processes discussed in detail with respect to FIGS. 1-4. The mass storage device 15, the ROM 16, and the RAM 14 may also store other types of program modules.

Based on the foregoing, it should be appreciated that technologies for transacted double buffering of a graphical user interface while providing a splash screen display are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for updating a graphical user interface, the method comprising:
initiating (310) a transaction in response to a requested operation;
identifying (322) one or more windows associated with the requested operation;
double buffering (325) user interface updates associated with the one or more windows;
detecting completion (340) of the requested operation;
terminating (350) the transaction in response to detecting completion of the requested operation; and
committing (355) double buffered user interface updates to a computer display after terminating the transaction.

2. The method of claim 1, wherein identifying one or more windows associated with the requested operation comprises identifying a plurality of windows associated with the requested operation.

3. The method of claim 1, wherein initiating the transaction in response to a requested operation comprises initiating the transaction in response to a requested operation to be performed over an extended or unknown amount of time.

4. The method of claim 1, wherein double buffering user interface updates associated with the one or more windows comprises providing an off screen rendering buffer for drawing user interface updates.

5. The method of claim 1, wherein double buffering user interface updates associated with the one or more windows comprises providing a transparent layered window for drawing user interface updates.

6. The method of claim 5, wherein committing double buffered user interface updates to a computer display comprises turning off a transparency parameter associated with the layered window.

7. The method of claim 1, further comprising providing a splash screen during the transaction.

8. The method of claim 7, further comprising providing a distinct splash screen thread.

9. The method of claim 1, further comprising providing a cancellation option during the transaction.

10. The method of claim 1, further comprising providing a progress indicator during the transaction.

11. A computer storage medium (15) having computer executable instructions stored thereon which, when executed by a computer (5), cause the computer to:
initiate (310) a transaction in response to a requested operation;
identify (322) one or more windows associated with the requested operation;
double buffer (325) user interface updates associated with the one or more windows;
provide (400) a splash screen (160) during the transaction;
detect completion (340) of the requested operation;
terminate (350) the transaction in response to detecting completion of the requested operation; and
commit (355) double buffered user interface updates to a computer display after terminating the transaction.

12. The computer storage medium of claim 11, wherein identifying one or more windows associated with the requested operation comprises identifying a plurality of windows associated with the requested operation.

13. The computer storage medium of claim 11, wherein initiating the transaction in response to a requested operation comprises initiating the transaction in response to a requested operation to be performed over an extended or unknown amount of time.

14. The computer storage medium of claim 11, wherein double buffering user interface updates associated with the one or more windows comprises providing an off screen rendering buffer for drawing user interface updates.

15. The computer storage medium of claim 11, wherein double buffering user interface updates associated with the one or more windows comprises providing a transparent layered window for drawing user interface updates.

16. The computer storage medium of claim 15, wherein committing double buffered user interface updates to a computer display comprises turning off a transparency parameter associated with the layered window.

17. The computer storage medium of claim 11, further comprising causing the computer to provide a distinct splash screen thread.

18. The computer storage medium of claim 11, further comprising causing the computer to provide a cancellation option during the transaction.

19. The computer storage medium of claim 11, further comprising causing the computer to provide a progress indicator during the transaction.

20. A graphical user interface system comprising:
a processing unit (10); and
one or more modules operable to cause the processing unit (10) to initiate (310) a transaction in response to a requested operation requiring an extended or unknown amount of time, identify (322) a plurality of windows associated with the requested operation, provide (325) an off screen rendering buffer for drawing user interface updates associated with the plurality of windows, terminate (350) the transaction in response to detecting completion of the requested operation, and commit (355) off screen rendering buffer to a computer display after terminating the transaction.
